(19) United States
(12) Patent Application Publication
(10) Pub. No.: US 2014/0330492 A1
(43) Pub. Date: Nov. 6, 2014

(54) ENGINE CONTROL DEVICE FOR VEHICLE

(71) Applicants: Yoshio Hasegawa, Chiryu-shi (JP); Keisuke Ota, Toyota-shi (JP)

(72) Inventors: Yoshio Hasegawa, Chiryu-shi (JP); Keisuke Ota, Toyota-shi (JP)

(73) Assignee: TOYOTA JIDOSHA KABUSHIKI KAISHA, Toyota-shi, Aichi (JP)

(21) Appl. No.: 14/363,031

(22) PCT Filed: Dec. 9, 2011
(86) PCT No.: PCT/JP2011/078600

§ 371 Date: Jun. 5, 2014

(51) Int. Cl. F02D 41/00; B60W 10/10; B60W 10/06; F02D 41/04

(52) U.S. Cl. CPC F02D 41/0007; F02D 41/04; B60W 10/10; B60W 10/06
USPC 701/54; 701/102

(57) ABSTRACT

A vehicle engine control device in a vehicle including an engine, a supercharger pressurizing intake air of the engine, a supercharging pressure adjustment mechanism adjusting a supercharging pressure of the supercharger, and a stepped automatic transmission outputting power of the engine to drive wheels provides supercharging pressure suppression control of actuating the supercharging pressure adjustment mechanism so as to suppress a rise in the supercharging pressure in a process of a rise in the supercharging pressure of the supercharger, the supercharging pressure suppression control is limited during a shift of the automatic transmission as compared to after the shift of the automatic transmission.

### TECHNICAL FIELD

The present invention relates to a technique of reducing a shift shock in a vehicle including an engine with a supercharger and an automatic transmission.

### BACKGROUND ART

In a vehicle including an engine, a supercharger pressurizing intake air of the engine, and a stepped automatic transmission outputting power of the engine to drive wheels, a vehicle engine control device has hitherto been well known that controls a supercharging pressure of the supercharger. For example, this corresponds to a vehicle engine control device of Patent Document 1. The vehicle engine control device uses feed-forward control and feed-back control at the same time to control the supercharging pressure. Specifically, a value is acquired by adding a control value of supercharging pressure decided by the feed-back control to a control value of supercharging pressure decided by the feed-forward control and is used as supercharging pressure control output for controlling the supercharging pressure. The vehicle engine control device inhibits the feed-back control of the supercharging pressure and controls the supercharging pressure only through the feed-forward control at the time of downshift of the automatic transmission so as to prevent the supercharging pressure from unnecessarily rising. The supercharging pressure at the time of the downshift is reduced in this way.

### PRIOR ART DOCUMENTS

### Patent Documents

Patent Document 1: Japanese Laid-Open Patent Publication No. 2010-242722
Patent Document 2: Japanese Laid-Open Patent Publication No. 9-42000
Patent Document 3: Japanese Laid-Open Patent Publication No. 7-195963

### SUMMARY OF THE INVENTION

### Problem to be Solved by the Invention

If supercharging pressure is reduced during the shift and the reduction of the supercharging pressure is canceled after completion of the shift as in the vehicle engine control device of Patent Document 1 described above, since engine torque increases with a delay from an increase in supercharging pressure, responsiveness of drive force may deteriorate or engine torque may not smoothly increase due to a delay in rise of the supercharging pressure, resulting in reduced comfort. It is conceivable that the reduction in responsiveness tends to occur more significantly at the time of skip shift. For example, when the supercharging pressure rises during a shift of the automatic transmission, if it is attempted to actively suppress the rise in the supercharging pressure, this may lead to making a shift shock larger depending on timing of the suppression. For example, if a rise in the supercharging pressure is suppressed and engine torque is abruptly changed at a shift ending period of the automatic transmission, a shift shock may be made larger. The problem as described above is unknown.

The present invention was conceived in view of the situations and it is therefore an object of the present invention to provide a vehicle engine control device capable of reducing a shift shock while avoiding deterioration in responsiveness of drive force in a vehicle including an engine, a supercharger pressurizing intake air of the engine, and an automatic transmission.

### Means for Solving the Problem

To achieve the object, the first aspect of the invention provides (a) a vehicle engine control device in a vehicle including an engine, a supercharger pressurizing intake air of the engine, a supercharging pressure adjustment mechanism adjusting a supercharging pressure of the supercharger, and a stepped automatic transmission outputting power of the engine to drive wheels, the vehicle engine control device providing supercharging pressure suppression control of actuating the supercharging pressure adjustment mechanism so as to suppress a rise in the supercharging pressure in a process of a rise in the supercharging pressure of the supercharger, (b) the supercharging pressure suppression control being limited during a shift of the automatic transmission as compared to after the shift of the automatic transmission.

### Effects of the Invention

As a result, since the rise in the supercharging pressure is hardly suppressed in a forcible manner during a shift of the automatic transmission, deterioration in responsiveness of drive force can be avoided. Since an abrupt change in engine torque hardly occurs due to the provision of the supercharging pressure suppression control during a shift, the shift shock of the automatic transmission can be reduced.

The second aspect of the invention provides the vehicle engine control device recited in the first aspect of the invention, wherein the shift of the automatic transmission associated with limitation on the supercharging pressure suppression control is a power-on downshift executed due to a depressing operation of an accelerator pedal. Consequently, when a driver requests higher responsiveness of drive force, deterioration in the responsiveness of drive force is properly avoided.

The third aspect of the invention provides the vehicle engine control device recited in the first or second aspect of the invention, wherein the limitation on the supercharging pressure suppression control is to limit actuation of the supercharging pressure adjustment mechanism in the supercharging pressure suppression control when a progress rate of a shift of the automatic transmission is closer to completion of the shift. Consequently, the actuation of the supercharging pressure adjustment mechanism for suppressing a rise in the supercharging pressure in the supercharging pressure suppression control can be limited without excess or shortage in terms of avoiding deterioration in responsiveness of drive force and reducing the shift shock, as compared to the case of uniformly limiting the actuation during a shift of the automatic transmission, for example.

The fourth aspect of the invention provides the vehicle engine control device recited in any one of the first to third aspects of the invention, wherein the limitation on the supercharging pressure suppression control is to delay a start time of actuation of the supercharging pressure adjustment mechanism until completion of the shift of the automatic transmission when the supercharging pressure suppression control is provided. Consequently, since the supercharging pressure adjustment mechanism is not automatically actuated to suppress the rise in the supercharging pressure in a shift ending period of the automatic transmission, an abrupt change in the engine torque in the shift ending period can highly certainly be avoided and the shift shock can be reduced.

The fifth aspect of the invention provides the vehicle engine control device recited in any one of the first to fourth aspects of the invention, wherein actuation of the supercharging pressure adjustment mechanism in the supercharging pressure suppression control is limited when a progress rate of the shift is equal to or greater than a predefined shift progress rate threshold value during a shift of the automatic transmission. Consequently, when the supercharging pressure suppression control is provided, it can simply be determined by using the shift progress rate threshold value whether the actuation of the supercharging pressure adjustment mechanism is limited in the supercharging pressure suppression control, and control load of the vehicle engine control device may be reduced.

The sixth aspect of the invention provides the vehicle engine control device recited in any one of the first to fifth aspects of the invention, wherein the supercharging pressure suppression control is provided when a supercharging pressure of the supercharger is equal to or greater than a predefined supercharging pressure suppression threshold value. Consequently, it can simply be determined by using the supercharging pressure suppression threshold value whether the supercharging pressure suppression control is provided so as not to make the supercharging pressure of the supercharger excessively high, and the control load of the vehicle engine control device may be reduced.

Preferably, the supercharger is an exhaust turbine supercharger driven by exhaust of the engine.

Preferably, the automatic transmission includes planetary gear devices and a plurality of engagement devices and the shift of the automatic transmission is a shift by switching the engagement devices to be gripped.

Preferably, a limitation of the supercharging pressure suppression control means delay of the start time of actuation of the supercharging pressure adjustment mechanism until completion of the shift when the supercharging pressure suppression control is provided, or reduction of an actuation amount or actuation speed when the supercharging pressure adjustment mechanism is actuated in the direction of suppressing the rise in the supercharging pressure in the supercharging pressure suppression control as compared to the case that the supercharging pressure suppression control is not limited.

Preferably, the vehicle engine control device determines the shift progress rate threshold value based on the engine rotation speed before start of a shift of the automatic transmission. Since responsiveness of the supercharging pressure to the actuation of the supercharging pressure adjustment mechanism becomes higher when the engine rotation speed is higher, an effect of the provision of the supercharging pressure suppression control on the amplitude of the shift shock differs depending on a level of the engine rotation speed. Therefore, as compared to the case that the shift progress rate threshold value is a constant value, an opportunity of limiting the actuation of the supercharging pressure adjustment mechanism in the supercharging pressure suppression control during a shift of the automatic transmission can be obtained without excess or shortage.

### BRIEF DESCRIPTION OF THE DRAWINGS

FIG. 1 is a schematic for explaining a configuration of a vehicle drive device included in a vehicle to which the present invention is preferably applied.

FIG. 2 is an operation table for explaining an operation state of engagement elements when each of a plurality of shift stages (gear stages) is established in the automatic transmission included in the vehicle drive device of FIG. 1.

FIG. 3 is a diagram of exemplary illustration of signals input to the electronic control device for controlling the vehicle drive device of FIG. 1 and is a functional block diagram for explaining a main portion of the control function included in the electronic control device.

FIG. 4 is a flowchart for explaining a main portion of the control operation of the electronic control device of FIG. 3, i.e., the control operation of providing the supercharging pressure suppression control at the time of shift of the automatic transmission.

FIG. 5 is a time chart for explaining the flowchart of FIG. 4 by taking as an example a power-on downshift when the accelerator pedal is deeply depressed to perform a downshift of the automatic transmission in the vehicle of FIG. 1.

### MODE FOR CARRYING OUT THE INVENTION

An example of the present invention will now be described in detail with reference to the drawings.

### Example

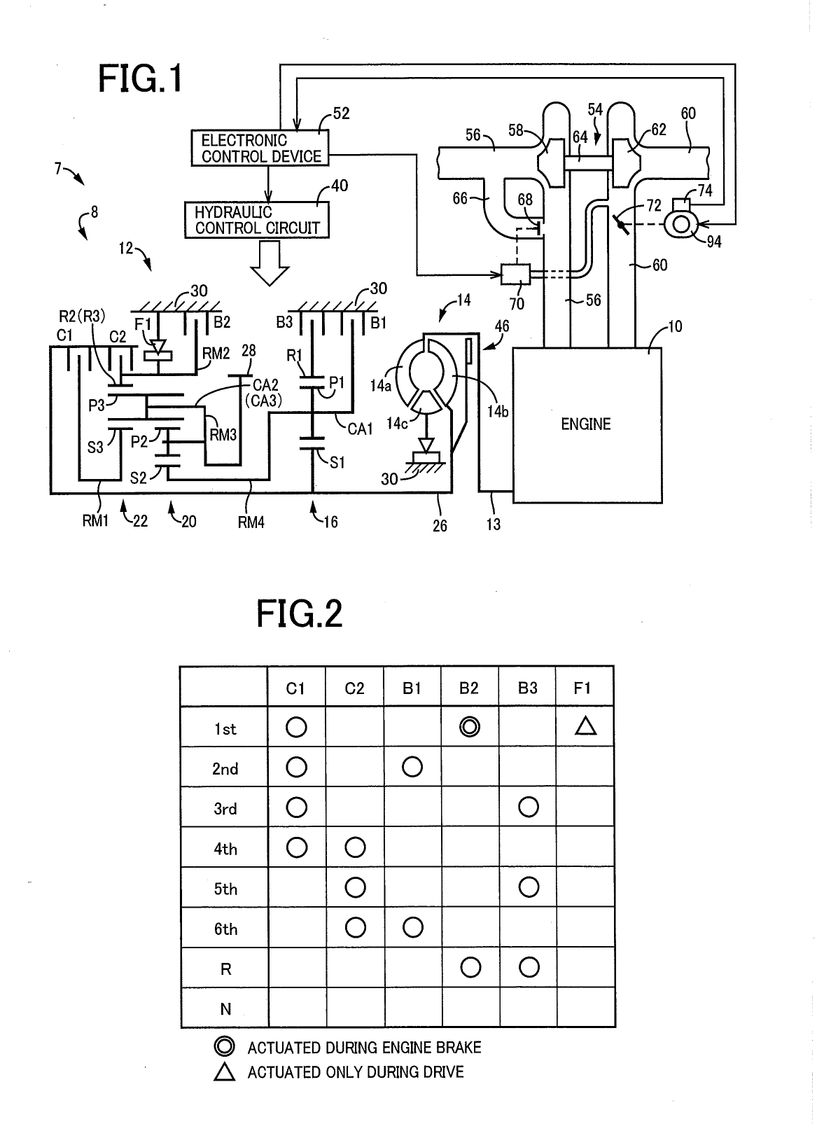

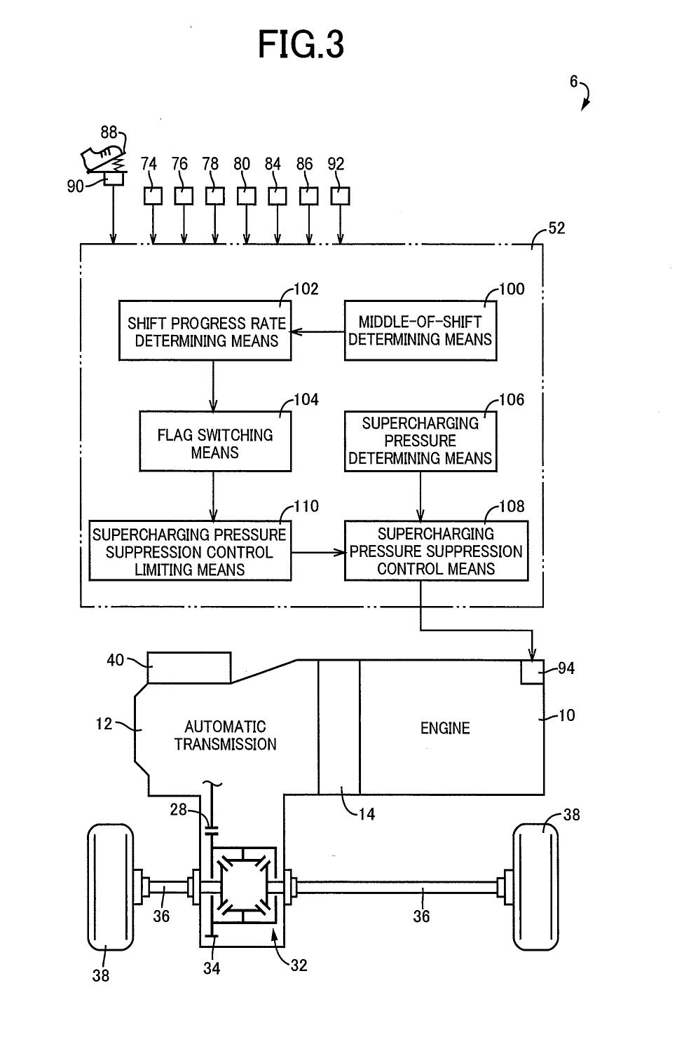

FIG. 1 is a schematic for explaining a configuration of a vehicle drive device 7 included in a vehicle 6 to which the present invention is preferably applied. The vehicle 6 includes the vehicle drive device 7, a pair of drive wheels 38, etc., and the vehicle drive device 7 includes a vehicle power transmission device 8 (hereinafter referred to as a “power transmission device 8”) and an engine 10. The power transmission device 8 is interposed between the engine 10 and the drive wheels 38 and includes an automatic transmission 12 and a torque converter 14 coupled to an output shaft 13 of the engine 10 and interposed between the engine 10 and the automatic transmission 12. The power transmission device 8 is preferably used in an FF vehicle in which the power transmission device 8 is equipped in the lateral direction of (transversely mounted on) the vehicle 6 (see FIG. 3).

The automatic transmission 12 makes up a portion of a power transmission path from the engine 10 to the drive wheels 38 (see FIG. 3) and outputs a power of the engine 10 toward the drive wheels 38. Therefore, the power of the engine 10 input to a transmission input shaft 26 is output from an output gear 28 toward the drive wheels 38. The automatic transmission 12 is a stepped transmission including a plurality of planetary gear devices 16, 20, 22, a plurality of hydraulic friction engagement devices (clutches C and brakes B), or specifically, five hydraulic friction engagement devices (C1, C2, B1, B2, B3), and a unidirectional clutch F1, and selectively establishing a plurality of shift stages (gear stages) by switching any of the multiple hydraulic friction engagement devices to be gripped. For example, the automatic transmission 12 performs a shift in accordance with a relationship (shift diagram) set in advance based on a vehicle state represented by a vehicle speed V and an accelerator opening degree Acc. In short, the automatic transmission 12 is a stepped transmission performing a so-called clutch-to-clutch shift frequently used in typical vehicles. Specifically, the first planetary gear device 16 of the automatic transmission 12 is of a single pinion type and includes a first sun gear S1, a first pinion gear P1, a first carrier CA1, and a first ring gear R1. The second planetary gear device 20 is of a double pinion type and includes a second sun gear S2, a second pinion gear P2, a third pinion gear P3, a second carrier CA2, and a second ring gear R2. The third planetary gear device 22 is of a single pinion type and includes a third sun gear S3, the third pinion gear P3, a third carrier CA3, and a third ring gear R3. The second planetary gear device 20 and the third planetary gear device 22 are formed as a Ravigneaux type planetary gear train with the second and third ring gears R2 and R3 made up of a common member and the third pinion gear P3 of the third planetary gear device 22 used also as one of the pinion gears of the second planetary gear device 20. As can be seen from FIG. 1, the transmission input shaft 26 acting as an input rotating member of the automatic transmission 12 is a turbine shaft of the torque converter 14. The output gear 28 acting as an output rotating member of the automatic transmission 12 functions as a differential drive gear meshed with a differential driven gear (large diameter gear) 34 of a differential gear device 32 (see FIG. 3). Output of the engine 10 is transmitted through the torque converter 14, the automatic transmission 12, the differential gear device 32, and a pair of axles 36 to a pair of the drive wheels (front wheels) 38 (see FIG. 3). The automatic transmission 12 is substantially symmetrically configured relative to a center line and the lower half from the center line is not depicted in FIG. 1.

FIG. 2 is an operation table for explaining an operation state of engagement elements when each of a plurality of shift stages (gear stages) is established in the automatic transmission 12. The operation table of FIG. 2 summarizes the relationship between the shift stages and the operation state of the clutches C1, C2, and the brakes B1 to B3 with “circles” indicative of engagement, a “double circle” indicative of engagement only during engine brake, and a “triangle” indicative of engagement only during drive. As depicted in FIG. 2, the automatic transmission 12 has six forward shift stages from a first speed gear stage “1st” to a sixth speed gear stage “6th” and a reverse shift stage of a reverse shift stage “R” established depending on the operation state of the engagement elements (the clutches C1, C2, and the brakes B1 to B3). Since the unidirectional clutch F1 is disposed in parallel with the brake B2 establishing the first shift stage “1st”, the brake B2 may not necessarily be engaged at startup (at the time of acceleration). A shift ratio γat of the automatic transmission 12 is calculated based on an input rotation speed Nin that is a rotation speed Nin of the transmission input shaft 26 and an output rotation speed Nout that is a rotation speed Nout of an output gear 28 from an equation “shift ratio γat=input rotation speed Nin/output rotation speed Nout”.

The clutches C1, C2, and the brakes B1 to B3 (hereinafter simply referred to as clutches C and brakes B if not particularly distinguished) are hydraulic friction engagement devices subjected to engagement control by hydraulic actuators, such as multiplate clutches and brakes, and have engaged and released states switched, and transient oil pressures at the time of engagement and release controlled, by excitation/non-excitation and current control of a linear solenoid valve disposed in a hydraulic control circuit 40 (see FIG. 1).

The torque converter 14 includes a pump impeller 14a coupled to the output shaft 13 (crankshaft) of the engine 10, a turbine impeller 14b coupled to the transmission input shaft 26 of the automatic transmission 12, and a stator impeller 14c coupled via the unidirectional clutch to a housing (transmission case) 30 of the automatic transmission 12 and is a fluid transmission device transmitting the drive force generated by the engine 10 through fluid to the automatic transmission 12. A lockup clutch 46 is a direct clutch disposed between the pump impeller 14a and the turbine impeller 14b and is put into an engaged state, a slip state, or a released state through hydraulic control etc. The lockup clutch 46 is put into an engaged state, or strictly, a completely engaged state, to integrally rotate the pump impeller 14a and the turbine impeller 14b.

A supercharger 54 is disposed in an intake system of the engine 10 and is a known exhaust turbine supercharger, i.e., a turbocharger, rotationally driven by exhaust of the engine 10 to pressurize intake air of the engine 10. Specifically, as depicted in FIG. 1, the supercharger 54 includes an exhaust turbine wheel 58 disposed in an exhaust pipe 56 of the engine 10 and rotationally driven by exhaust of the engine 10, an intake compressor wheel 62 disposed in an intake pipe 60 of the engine 10 and rotated by the exhaust turbine wheel 58 to compress intake air of the engine 10, an a rotation shaft 64 coupling the exhaust turbine wheel 58 and the intake compressor wheel 62. When the exhaust of the engine 10 sufficient for driving the supercharger 54 is led to the exhaust turbine wheel 58, the engine 10 operates in a supercharged state in which the engine 10 is supercharged by the supercharger 54. On the other hand, if the exhaust of the engine 10 led to the exhaust turbine wheel 58 is insufficient for driving the supercharger 54, the supercharger 54 is almost not driven and the engine 10 operates in a state of supercharging suppressed as compared to the supercharged state, i.e., a natural aspiration state (also referred to as NA state), which is a state of intake air equivalent to a natural aspirated engine without the supercharger 54.

Additionally, an exhaust bypass path 66 is disposed in parallel with an exhaust path in which the exhaust turbine wheel 58 in the exhaust pipe 56 is disposed, and a waist gate valve 68 is disposed that opens and closes the exhaust bypass path 66. The waist gate valve 68 has an opening degree θwg of the waist gate valve 68 made continuously adjustable (hereinafter referred to as a waist gate valve opening degree θwg), and an electronic control device 52 controls an electric actuator 70 to continuously open and close the waist gate valve 68 by utilizing pressure in the intake pipe 60. For example, when the waist gate valve opening degree θwg is larger, the exhaust of the engine 10 is more easily discharged through the exhaust bypass path 66 and, therefore, in the supercharged state in the engine 10, a downstream air pressure PLin of the intake compressor wheel 62 in the intake pipe 60, i.e., a supercharging pressure Pcmout (=PLin) of the supercharger 54, becomes lower when the waist gate valve opening degree θwg is larger. As is generally known, the supercharging pressure Pcmout of the supercharger 54 becomes lower when an opening degree θth of an electronic throttle valve 72, i.e., a throttle opening degree θth, is smaller in the supercharged state of the engine 10. Therefore, in this example, the electronic throttle valve 72 acts as a supercharging pressure adjustment mechanism adjusting the supercharging pressure Pcmout. Unless otherwise noted, the waist gate valve 68 is assumed to be in a completely closed state in the description of this example.

FIG. 3 is a diagram of exemplary illustration of signals input to the electronic control device 52 acting as a control device for controlling the vehicle drive device 7 of this example and is a functional block diagram for explaining a main portion of the control function included in the electronic control device 52. The electronic control device 52 includes a so-called microcomputer consisting of a CPU, a ROM, a RAM, an I/O interface, etc., executes signal processes in accordance with programs stored in advance in the ROM, while utilizing a temporary storage function of the RAM, to provide vehicle control related to the engine 10 and the automatic transmission 12. For example, the electronic control device 52 acts as a vehicle engine control device controlling the engine 10.

The electronic control device 52 is supplied, from sensors, switches, etc. as depicted in FIG. 3, with a signal indicative of a throttle opening degree θth of the engine 10 detected by a throttle opening degree sensor 74, a signal indicative of an upstream air pressure PHin of the intake compressor wheel 62 in the intake pipe 60 (hereinafter referred to as a compressor upstream intake pressure PHin) detected by a first intake sensor 76, a signal indicative of the downstream air pressure PLin of the intake compressor wheel 62 in the intake pipe 60 (hereinafter referred to as a compressor downstream intake pressure PLin) detected by a second intake sensor (supercharging pressure sensor) 78, a signal indicative of vehicle longitudinal acceleration ACL that is acceleration ACL in a vehicle running direction, i.e., a vehicle longitudinal direction, detected by an acceleration sensor 80, a signal indicative of an engine rotation speed Ne detected by an engine rotation speed sensor 84, a signal from a vehicle speed sensor 86 indicative of the vehicle speed V corresponding to the rotation speed Nout of the output gear 28, a signal from an accelerator opening degree sensor 90 indicative of the accelerator opening degree Acc that is an operation amount of an accelerator pedal 88 corresponding to a request output of a driver, a signal from a turbine rotation speed sensor 92 indicative of a rotation speed Nt of the turbine impeller 14b (hereinafter referred to as “turbine rotation speed Nt”), i.e., a rotation speed Nin (=Nt) of the transmission input shaft 26, and the like.

The electronic control device 52 supplies various output signals to the devices disposed on the vehicle 6. For example, the electronic control device 52 provides throttle control through an electric throttle actuator 94 to adjust the throttle opening degree θth depending on the accelerator opening degree Acc and basically increases the throttle opening degree θth as the accelerator opening degree Acc increases in the throttle control.

As depicted in FIG. 3, the electronic control device 52 functionally includes a middle-of-shift determining means 100 that is a middle-of-shift determining portion, a shift progress rate determining means 102 that is a shift progress rate determining portion, a flag switching means 104 that is a flag switching portion, a supercharging pressure determining means 106 that is a supercharging pressure determining portion, a supercharging pressure suppression control means 108 that is a supercharging pressure suppression control portion, and a supercharging pressure suppression control limiting means 110 that is a supercharging pressure suppression control limiting portion.

The middle-of-shift determining means 100 determines whether the automatic transmission 12 is in the middle of shift. Although when the automatic transmission 12 is in the middle of shift, the automatic transmission 12 may be in a period acquired by combining a torque phase and an inertia phase of the shift, the middle-of-shift determining means 100 of this example determines that the automatic transmission 12 is in the middle of shift when the automatic transmission 12 is in a period of the inertia phase. Whether the automatic transmission 12 is in the middle of shift can be determined from, for example, a change in the input rotation speed Nin of the automatic transmission 12, or a control signal of a linear solenoid valve in the hydraulic control circuit 40 engaging or releasing the clutches C or the brakes B of the automatic transmission 12.

If the middle-of-shift determining means 100 determines that the automatic transmission 12 is in the middle of shift, the shift progress rate determining means 102 sequentially detects the input rotation speed Nin (=Nt) of the automatic transmission 12 and sequentially calculates a progress rate of the shift, i.e., a shift progress rate PRat, of the automatic transmission 12 based on the input rotation speed Nin. Specifically, at the start of a shift of the automatic transmission 12, the shift progress rate determining means 102 acquires a shift start time input rotation speed N01in that is the input rotation speed Nin at the start of the shift, and calculates a shift completion time target input rotation speed N02 in that is the input rotation speed Nin defined as a target at the completion of the shift, based on a target shift stage after the shift and the vehicle speed V. The shift progress rate PRat of the automatic transmission 12 is then calculated from the following Equation (1) based on the shift start time input rotation speed N01in, the shift completion time target input rotation speed N02 in and the current input rotation speed Nin (=Nt) detected by the turbine rotation speed sensor 92. Therefore, the shift progress rate PRat has a value set to zero at the start of a shift, continuously increasing as the shift progresses, and becoming one at the completion of the shift.

PRat=(Nin−N01in)/(N02in−N01in) (1)

The shift progress rate determining means 102 determines whether the shift progress rate PRat of the automatic transmission 12 is equal to or greater than a predefined shift progress rate threshold value PR1at. The shift progress rate threshold value PR1at is a threshold value set to indicate that a shift of the automatic transmission 12 enters a shift ending period if the shift progress rate PRat becomes equal to or greater than the shift progress rate threshold value PR1at, and is empirically set in advance such that, for example, if the shift progress rate PRat becomes equal to or greater than the shift progress rate threshold value PR1at, it can be determined that a start of provision of supercharging pressure suppression control described later should be limited so as to suppress a shift shock of the automatic transmission 12. For example, although the shift progress rate threshold value PR1at may be a constant value, the engine rotation speed Ne before start of a shift of the automatic transmission 12, or particularly, the engine rotation speed Ne at the start of the shift is acquired in this example and the shift progress rate threshold value PR1 at is decided from a preliminarily empirically defined relationship based on the engine rotation speed Ne before start of the shift. The shift progress rate threshold value PR1 at may be decided based on a vehicle state represented by the throttle opening degree θth or input torque to the automatic transmission 12 before start of the shift, or may be decided based on a shift stage before start of the shift and a target shift stage after completion of the shift.

If the shift progress rate determining means 102 determines that the shift progress rate PRat of the automatic transmission 12 is equal to or greater than the shift progress rate threshold value PR1at, the flag switching means 104 switches a supercharging pressure suppression control change flag FLAG01 indicative of whether the provision of the supercharging pressure suppression control described later is limited, from off (OFF) to on (ON). If the shift of the automatic transmission 12 is completed, the supercharging pressure suppression control change flag FLAG01 is switched from on to off. Therefore, the supercharging pressure suppression control change flag FLAG01 is turned on from when the shift progress rate PRat of the automatic transmission 12 becomes equal to or greater than the shift progress rate threshold value PR1at until completion of the shift.

The supercharging pressure determining means 106 sequentially detects the supercharging pressure Pcmout (=PLin) of the supercharger 54 with the second intake sensor 78 and determines whether the supercharging pressure Pcmout is equal to or greater than a predefined supercharging pressure suppression threshold value P1cmout. The supercharging pressure suppression threshold value P1cmout is empirically set in advance such that the supercharging pressure suppression control described later is properly provided without making the supercharging pressure Pcmout excessively large in terms of maintenance of durability, improvement in fuel efficiency, etc. of the engine 10 and that an opportunity of suppressing the supercharging pressure Pcmout through the supercharging pressure suppression control is reduced as small as possible in terms of improvement in drivability. Since a change in the supercharging pressure Pcmout is associated with a response delay, the supercharging pressure suppression threshold value P1 cmout is set with a margin in consideration of the response delay of the supercharging pressure Pcmout. The supercharging pressure suppression threshold value P1cmout is set to a constant value, for example.

If the supercharging pressure determining means 106 determines that the supercharging pressure Pcmout of the supercharger 54 is equal to or greater than the supercharging pressure suppression threshold value P1cmout, the supercharging pressure suppression control means 108 provides the supercharging pressure suppression control for suppressing the supercharging pressure Pcmout. Specifically, the supercharging pressure suppression control is control of actuating the electronic throttle valve 72 so as to suppress a rise in the supercharging pressure Pcmout in the process of a rise in the supercharging pressure Pcmout of the supercharger 54. In other words, when the throttle opening degree θth is made smaller, the supercharging pressure Pcmout becomes more difficult to rise and, therefore, in the supercharging pressure suppression control, even when the accelerator opening degree Acc does not decrease, the supercharging pressure suppression control means 108 automatically actuates the electronic throttle valve 72 in the closing direction to stop the rise in the supercharging pressure Pcmout. In particular, since the electronic throttle valve 72 is actuated depending on the accelerator opening degree Acc through the throttle control and the throttle opening degree θth is therefore set to a degree corresponding to the accelerator opening degree Acc, the supercharging pressure suppression control means 108 actuates the electronic throttle valve 72 in the supercharging pressure suppression control such that the throttle opening degree θth becomes smaller than the degree corresponding to the accelerator opening degree Acc through the throttle control, thereby stopping the rise in the supercharging pressure Pcmout. An actuation amount and an actuation speed of the electronic throttle valve 72 in the supercharging pressure suppression control are empirically set in advance, for example, such that a passenger does not have a sense of discomfort due to a change in the supercharging pressure Pcmout through the supercharging pressure suppression control and that the rise in the supercharging pressure Pcmout promptly stops. The electronic throttle valve 72 corresponds to a supercharging pressure adjustment mechanism of the present invention. If the supercharging pressure Pcmout of the supercharger 54 becomes equal to or larger than the supercharging pressure suppression threshold value P1cmout, the supercharging pressure suppression control means 108 immediately provides the supercharging pressure suppression control to actuate the electronic throttle valve 72 in the closing direction; however, if the supercharging pressure suppression control limiting means 110 limits the actuation of the electronic throttle valve 72 in the supercharging pressure suppression control, the supercharging pressure suppression control means 108 may delay the start time of actuation of the electronic throttle valve 72 from when the supercharging pressure Pcmout becomes equal to or larger than the supercharging pressure suppression threshold value P1 cmout.

The supercharging pressure suppression control limiting means 110 provides supercharging pressure suppression actuation limitation control for limiting the actuation of the electronic throttle valve 72 in the closing direction in the supercharging pressure suppression control in the middle of shift of the automatic transmission 12 when the shift progress rate PRat of the shift is closer to the completion of the shift, i.e., when the shift progress rate PRat is closer to one. Specifically, if the shift progress rate PRat of the automatic transmission 12 is equal to or greater than the shift progress rate threshold value PR1at, the supercharging pressure suppression actuation limitation control is provided. In particular, the supercharging pressure suppression control limiting means 110 utilizes the supercharging pressure suppression control change flag FLAG01 and limits the actuation of the electronic throttle valve 72 in the closing direction in the supercharging pressure suppression control during a period while the supercharging pressure suppression control change flag FLAG01 is on. For example, during the period while the supercharging pressure suppression control change flag FLAG01 is on, when the supercharging pressure suppression control means 108 provides the supercharging pressure suppression control, the supercharging pressure suppression control limiting means 110 inhibits the supercharging pressure suppression control means 108 from actuating the electronic throttle valve 72 in the supercharging pressure suppression control. In other words, if the supercharging pressure suppression control change flag FLAG01 is on in the middle of shift of the automatic transmission 12, the supercharging pressure suppression control limiting means 110 delays the start time of actuation of the electronic throttle valve 72 in the supercharging pressure suppression control until completion of the shift when the supercharging pressure suppression control means 108 provides the supercharging pressure suppression control. In short, when it is described that the supercharging pressure suppression control limiting means 110 limits the actuation of the electronic throttle valve 72 in the closing direction in the supercharging pressure suppression control in the middle of shift of the automatic transmission 12, this means that when the supercharging pressure suppression control means 108 provides the supercharging pressure suppression control, the supercharging pressure suppression control limiting means 110 delays the start time of actuation of the electronic throttle valve 72 in the supercharging pressure suppression control until completion of the shift.

Although the supercharging pressure suppression control limiting means 110 delays the start time of actuation of the electronic throttle valve 72 in the supercharging pressure suppression control until completion of the shift in the supercharging pressure suppression actuation limitation control, the supercharging pressure suppression control limiting means 110 may limit the actuation of the electronic throttle valve 72 in the supercharging pressure suppression actuation limitation control by another method instead of the delay of the start time of the actuation or along with the delay of the start time of the actuation. For example, an example of the other method is that if the supercharging pressure suppression control change flag FLAG01 is on, the supercharging pressure suppression control limiting means 110 reduces an actuation amount or actuation speed when the supercharging pressure suppression control means 108 actuates the electronic throttle valve 72 in the direction of stopping the rise in the supercharging pressure Pcmout (closing direction) in the supercharging pressure suppression control as compared to the case that the supercharging pressure suppression control change flag FLAG01 is off. In other words, when it is described that the supercharging pressure suppression control limiting means 110 limits the actuation of the electronic throttle valve 72 in the closing direction in the supercharging pressure suppression control in the middle of shift of the automatic transmission 12, this means that the supercharging pressure suppression control limiting means 110 reduces an actuation amount or actuation speed when the supercharging pressure suppression control means 108 actuates the electronic throttle valve 72 in the direction of stopping the rise in the supercharging pressure Pcmout (closing direction) in the supercharging pressure suppression control as compared to the case that the actuation of the electronic throttle valve 72 is not limited. In this case, even if the supercharging pressure suppression control change flag FLAG01 is on, the supercharging pressure suppression control limiting means 110 may or may not delay the start time of actuation of the electronic throttle valve 72 in the supercharging pressure suppression control. If the actuation of the electronic throttle valve 72 is started due to provision of the supercharging pressure suppression control in the middle of shift of the automatic transmission 12, the supercharging pressure suppression control limiting means 110 may command the supercharging pressure suppression control means 108 to make the actuation speed of the electronic throttle valve 72 in the closing direction in the supercharging pressure suppression control smaller when the shift progress rate PRat at the start time of the actuation is lower, i.e., when the shift progress rate PRat at the start time of the actuation is closer to that at the start of the shift. The actuation amount and the actuation speed of the electronic throttle valve 72 in the case of limitation of the actuation of the electronic throttle valve 72 in the supercharging pressure suppression control by the supercharging pressure suppression control limiting means 110 are empirically set in advance such that a shift shock of the automatic transmission 12 is not made larger due to the provision of the supercharging pressure suppression control and that the rise in the supercharging pressure Pcmout stops as promptly as possible.

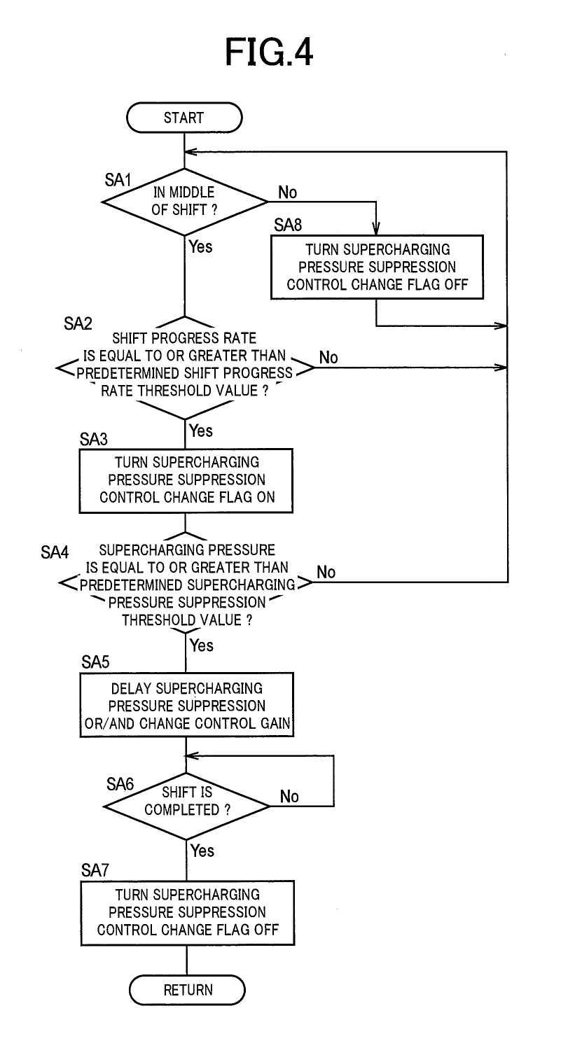

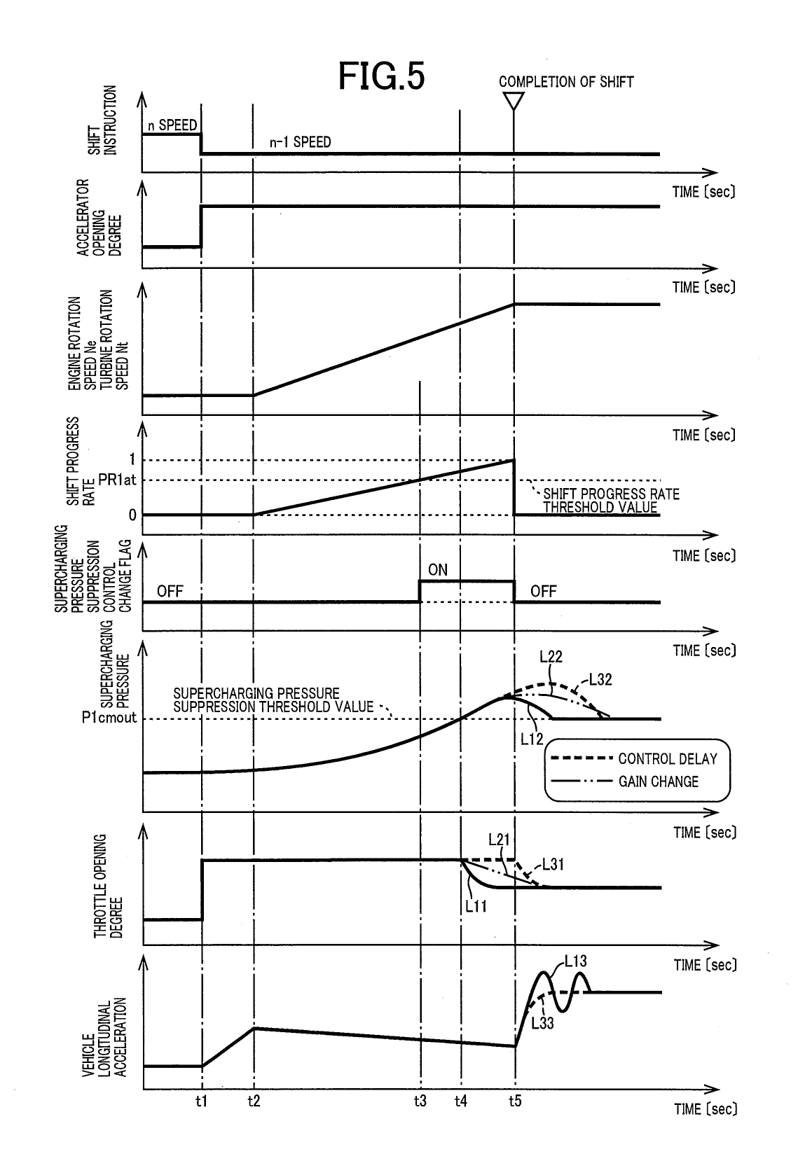

FIG. 4 is a flowchart for explaining a main portion of the control operation of the electronic control device 52, i.e., the control operation of providing the supercharging pressure suppression control at the time of shift of the automatic transmission 12, and is repeatedly executed with an extremely short cycle time, for example, on the order of a few msec to a few tens of msec. The control operation depicted in FIG. 4 is performed solely or concurrently with another control operation.

First, at step (hereinafter, “step” will be omitted) SA1, it is determined whether the automatic transmission 12 is in the middle of shift. If the determination of SA1 is affirmative, i.e., if the automatic transmission 12 is in the middle of shift, the operation goes to SA2. On the other hand, if the determination of SA1 is negative, the operation goes to SA8. SA1 corresponds to the middle-of-shift determining means 100.

At SA2 corresponding to the shift progress rate determining means 102, the shift progress rate PRat of the automatic transmission 12 is calculated. It is then determined whether the shift progress rate PRat is equal to or greater than the shift progress rate threshold value PR1at. If the determination of SA2 is affirmative, i.e., if the shift progress rate PRat is equal to or greater than the shift progress rate threshold value PR1 at, the operation goes to SA3. On the other hand, if the determination of SA2 is negative, the operation goes to SA1.

At SA3 corresponding to the flag switching means 104, the supercharging pressure suppression control change flag FLAG01 is set to be on (ON). SA3 is followed by SA4.

At SA4 corresponding to the supercharging pressure determining means 106, it is determined whether the supercharging pressure Pcmout of the supercharger 54 is equal to or greater than the supercharging pressure suppression threshold value P1cmout. If the determination of SA4 is affirmative, i.e., if the supercharging pressure Pcmout of the supercharger 54 is equal to or greater than the supercharging pressure suppression threshold value P1cmout, the operation goes to SA5. On the other hand, if the determination of SA4 is negative, the operation goes to SA1.

At SA5 corresponding to the supercharging pressure suppression control means 108 and the supercharging pressure suppression control limiting means 110, the supercharging pressure suppression control is provided. However, while the supercharging pressure suppression control change flag FLAG01 is on, the actuation of the electronic throttle valve 72 in the closing direction is limited in the supercharging pressure suppression control. Since the supercharging pressure suppression control change flag FLAG01 is turned on at SA3, the actuation of the electronic throttle valve 72 in the closing direction is limited at SA5. For example, limiting the actuation of the electronic throttle valve 72 in the closing direction in the supercharging pressure suppression control is to delay the supercharging pressure suppression through the supercharging pressure suppression control, or specifically, to delay the start time of actuation of the electronic throttle valve 72 until completion of the shift of the automatic transmission 12 when the supercharging pressure suppression control is provided. Alternatively, instead of the delay or in addition to the delay, the limiting may be to reduce the actuation amount or actuation speed when the electronic throttle valve 72 is actuated in the direction of stopping the rise in the supercharging pressure Pcmout in the supercharging pressure suppression control as compared to the case that the actuation of the electronic throttle valve 72 is not limited. To put it another way, reducing the actuation speed of the electronic throttle valve 72 is to change a control gain to the direction of reducing (lowering) the actuation speed in the control of actuating the electronic throttle valve 72. SA5 is followed by SA6.

At SA6 corresponding to the middle-of-shift determining means 100, it is determined whether the shift of the automatic transmission 12 is completed. If the determination of SA6 is affirmative, i.e., if the shift of the automatic transmission 12 is completed, the operation goes to SA7. On the other hand, if the determination of SA6 is negative, SA6 is repeated.

At SA7 corresponding to the flag switching means 104, the supercharging pressure suppression control change flag FLAG01 is set to be off (OFF). Although the actuation of the electronic throttle valve 72 in the closing direction in the supercharging pressure suppression control starts to be limited at SA5, since the supercharging pressure suppression control change flag FLAG01 is set to be off (OFF) at SA7, the limitation on actuation of the electronic throttle valve 72 is canceled.

At SA8 corresponding to the flag switching means 104, the supercharging pressure suppression control change flag FLAG01 is set to be off (OFF). If the supercharging pressure suppression control change flag FLAG01 is already off, the off state is continued.

FIG. 5 is a time chart for explaining the flowchart of FIG. 4 by taking as an example a power-on downshift when the accelerator pedal 88 is deeply depressed to perform a downshift of the automatic transmission 12. The downshift of the automatic transmission 12 performed in FIG. 5 is a shift performed by switching the clutches C or the brakes B to be gripped included in the automatic transmission 12, i.e., the clutch-to-clutch shift, such as a shift from the fourth speed to the third speed of the automatic transmission 12, for example. In FIG. 5, for simplicity of description, the lockup clutch 46 is assumed to be in the engaged state so as to represent the time charts of the engine rotation speed Ne and the turbine rotation speed Nt in the same chart.

Time t1 of FIG. 5 indicates a time point when the accelerator pedal 88 is deeply depressed. Therefore, in FIG. 5, the accelerator opening degree Acc increases in a stepped manner at time t1 and the throttle opening degree θth accordingly increases in a stepped manner. Because of the increase in the accelerator opening degree Acc, a shift instruction is given for performing the downshift of the automatic transmission 12. Because of the increase in the throttle opening degree θth at time t1, the vehicle longitudinal acceleration ACL gradually rises from time t1 to time t2. Since the throttle opening degree θth increases at time t1, the supercharging pressure Pcmout of the supercharger 54 starts rising with a response delay.

Between time t1 and time t2, the switching of the clutches C and the brakes B to be gripped is started for establishing the downshift of the automatic transmission 12, and an inertia phase of the downshift starts from time t2. In FIG. 5, the inertia phase corresponds to time t2 to time t5. Therefore, the determination of SA1 of FIG. 4 becomes affirmative at time t2. As the downshift progresses from time t2 of FIG. 5, the engine rotation speed Ne and the turbine rotation speed Nt gradually rise from time t2 to time t5, and the shift progress rate PRat of the automatic transmission 12 also gradually rises. As depicted in FIG. 5, the shift progress rate PRat is zero at time t2 when the shift of the automatic transmission 12 is started (when the inertia phase is started) and is one at time t5 when the shift is completed (when the inertia phase is terminated). In the period from time t2 to time t5, the automatic transmission 12 is in the inertia phase and, therefore, the vehicle longitudinal acceleration ACL gradually decreases.

Time t3 of FIG. 5 indicates a time point when the shift progress rate PRat becomes equal to or greater than the shift progress rate threshold value PR1at. Therefore, the determination of SA2 of FIG. 4 becomes affirmative at time t3 and, as a result, the supercharging pressure suppression control change flag FLAG01 is switched from off (OFF) to on (ON).

Time t5 indicates a time point of completion of the downshift and the rises in the engine rotation speed Ne and the turbine rotation speed Nt are terminated at time t5. The shift progress rate PRat of the automatic transmission 12 reaches one at time t5 when the shift is completed (when the downshift is completed) and then returns to zero after completion of the shift. Since the downshift is completed at time t5, the determination of SA6 of FIG. 4 becomes affirmative, and the supercharging pressure suppression control change flag FLAG01 is switched from on to off at SA7 of FIG. 4.

Time t4 of FIG. 5 indicates a time point when the supercharging pressure Pcmout in a rising process becomes equal to or greater than the supercharging pressure suppression threshold value P1cmout. Therefore, the determination of SA4 of FIG. 4 becomes affirmative at time t4 and, as a result, SA5 of FIG. 4 is executed. Since the supercharging pressure suppression control change flag FLAG01 is on at time t4, the actuation of the electronic throttle valve 72 in the closing direction in the supercharging pressure suppression control is limited; however, if it is assumed that the actuation of the electronic throttle valve 72 is not limited, the throttle opening degree θth immediately decreases from time t4 as usual as indicated by a solid line L11 of FIG. 5 and, therefore, the supercharging pressure Pcmout of the supercharger 54 changes as indicted by a solid line L12 and the rise in the supercharging pressure Pcmout is stopped. In this case, the input torque of the automatic transmission 12 is abruptly changed when the clutch C etc. are synchronized at the time of completion of the downshift, which causes the vehicle longitudinal acceleration ACL to oscillate as indicated by a solid line L13 immediately after time t5, and the shift shock is made larger.

On the other hand, in this example, the actuation of the electronic throttle valve 72 in the closing direction in the supercharging pressure suppression control is limited from time t3 to time t5 while the supercharging pressure suppression control change flag FLAG01 is on. For example, if the limitation on actuation of the electronic throttle valve 72 is achieved by reducing the actuation speed in actuation of the electronic throttle valve 72 in the direction of stopping the rise in the supercharging pressure Pcmout in the supercharging pressure suppression control as compared to the case that the actuation of the electronic throttle valve 72 is not limited (see the solid line L11 of FIG. 5), the throttle opening degree θth decreases from time t4 as indicated by a dashed-two dotted line L21. In other words, in the provision of the supercharging pressure suppression control, for example, the control gain for actuating the electronic throttle valve 72 is changed to make a time rate of decrease of the throttle opening degree θth smaller as compared to the solid line L11, and the electronic throttle valve 72 is actuated in the closing direction. As a result, the supercharging pressure Pcmout slowly changes as indicated by a dashed-two dotted line L22 as compared to the solid line L12, and the rise in the supercharging pressure Pcmout is stopped.

In another example, if the limitation on the actuation of the electronic throttle valve 72 in the supercharging pressure suppression control is achieved by delaying the start time of actuation of the electronic throttle valve 72 until completion of the shift of the automatic transmission 12 when the supercharging pressure suppression control is provided, the throttle opening degree θth decreases due to the provision of the supercharging pressure suppression control as indicated by a broken line L31. In other words, the start time of decrease in the throttle opening degree θth in the supercharging pressure suppression control is delayed from time t4 to time t5, and the throttle opening degree θth decreases from time t5 with the same decrease gradient as the solid line L11, for example. As a result, the supercharging pressure Pcmout starts decrease from time t5 with a sufficient delay as indicated by a broken line L32.

As described above, if the actuation of the electronic throttle valve 72 in the closing direction in the supercharging pressure suppression control is limited from time t3 to time t5, an expansion of the shift shock as indicated by the solid line L31 is avoided at the completion of the downshift, and the vehicle longitudinal acceleration ACL changes as indicated by a broken line L33 immediately after time t5.

According to this example, if the supercharging pressure Pcmout of the supercharger 54 is equal to or greater than the supercharging pressure suppression threshold value P1cmout, the supercharging pressure suppression control means 108 provides the supercharging pressure suppression control to actuate the electronic throttle valve 72 such that a rise in the supercharging pressure Pcmout is suppressed in the process of the rise in the supercharging pressure Pcmout of the supercharger 54, for example, such that the rise in the supercharging pressure Pcmout is stopped. As indicated in the time chart of FIG. 5, the supercharging pressure suppression control is limited in the middle of shift of the automatic transmission 12 as compared to after the shift of the automatic transmission 12. In other words, the supercharging pressure suppression control is limited as compared to when the automatic transmission 12 is not in the middle of shift. Therefore, since the rise in the supercharging pressure Pcmout is hardly suppressed in a forcible manner in the middle of shift of the automatic transmission 12, deterioration in responsiveness of drive force can be avoided. Since an abrupt change in engine torque hardly occurs due to the provision of the supercharging pressure suppression control in the middle of shift, the shift shock of the automatic transmission 12 can be reduced. In short, deterioration in drivability can be avoided.

According to this example, as depicted in the time chart of FIG. 5, for example, the shift of the automatic transmission 12 associated with the limitation on the supercharging pressure suppression control is the power-on downshift executed due to a depressing operation of the accelerator pedal 88. Therefore, when a driver requests higher responsiveness of drive force, deterioration in the responsiveness of drive force is properly avoided.

According to this example, the supercharging pressure suppression control limiting means 110 limits the actuation of the electronic throttle valve 72 in the closing direction in the supercharging pressure suppression control for the supercharging pressure suppression control means 108 in the middle of shift of the automatic transmission 12 when the shift progress rate PRat of the shift is closer to the completion of shift. In other words, the limitation on the supercharging pressure suppression control in the middle of shift of the automatic transmission 12 is achieved by limiting the actuation of the electronic throttle valve 72 in the closing direction in the supercharging pressure suppression control when the shift progress rate PRat of the shift is closer to the completion of shift. Therefore, the actuation of the electronic throttle valve 72 for suppressing a rise in the supercharging pressure Pcmout in the supercharging pressure suppression control can be limited without excess or shortage in terms of avoiding deterioration in responsiveness of drive force and reducing the shift shock, as compared to the case of uniformly limiting the actuation in the middle of shift of the automatic transmission 12, for example.

According to this example, when it is described that the actuation of the electronic throttle valve 72 in the supercharging pressure suppression control is limited in the middle of shift of the automatic transmission 12, this means that, for example, when the supercharging pressure suppression control is provided, the start time of actuation of the electronic throttle valve 72 is delayed until completion of the shift. Therefore, since the electronic throttle valve 72 is not automatically actuated to suppress the rise in the supercharging pressure Pcmout in a shift ending period of the automatic transmission 12, an abrupt change in engine torque Te in the shift ending period can highly certainly be avoided and the shift shock can be reduced.

According to this example, the supercharging pressure suppression control limiting means 110 limits the actuation of the electronic throttle valve 72 in the closing direction in the supercharging pressure suppression control if the shift progress rate PRat of the automatic transmission 12 is equal to or greater than the shift progress rate threshold value PR1at. Therefore, when the supercharging pressure suppression control is provided, it can simply be determined by using the shift progress rate threshold value PR1 at whether the actuation of the electronic throttle valve 72 is limited in the supercharging pressure suppression control, and control load of the electronic control device 52 may be reduced.

According to this example, the supercharging pressure suppression control means 108 provides the supercharging pressure suppression control if the supercharging pressure Pcmout of the supercharger 54 is equal to or greater than the supercharging pressure suppression threshold value P1 cmout. Therefore, it can simply be determined by using the supercharging pressure suppression threshold value P1cmout whether the supercharging pressure suppression control is provided so as not to make the supercharging pressure Pcmout of the supercharger 54 excessively high, and the control load of the electronic control device 52 may be reduced.

According to this example, the shift progress rate determining means 102 decides the shift progress rate threshold value PR1at based on the engine rotation speed Ne before start of a shift of the automatic transmission 12. Since responsiveness of the supercharging pressure Pcmout of the supercharger 54 to the actuation of the electronic throttle valve 72 becomes higher when the engine rotation speed Ne is higher, an effect of the provision of the supercharging pressure suppression control on the amplitude of the shift shock differs depending on a level of the engine rotation speed Ne. Therefore, as compared to the case that the shift progress rate threshold value PR1at is a constant value regardless of the engine rotation speed Ne, an opportunity of limiting the actuation of the electronic throttle valve 72 in the supercharging pressure suppression control in the middle of shift of the automatic transmission 12 can be obtained without excess or shortage.

Although the example of the present invention has been described in detail with reference to the drawings, this is merely an embodiment and the present invention can be implemented in variously modified and improved forms based on the knowledge of those skilled in the art.

For example, although the exhaust bypass path 66 and the waist gate valve 68 are disposed as depicted in FIG. 1 in the example, the vehicle 6 may be a vehicle without the exhaust bypass path 66 and the waist gate valve 68.

Although the electronic throttle valve 72 is caused to act as the supercharging pressure adjustment mechanism actuated to stop the rise in the supercharging pressure Pcmout in the supercharging pressure suppression control in the example, since the supercharging pressure Pcmout becomes more difficult to rise when the waist gate valve opening degree θwg increases, the waist gate valve 68 may be caused to act as the supercharging pressure adjustment mechanism in the supercharging pressure suppression control instead of the electronic throttle valve 72 or along with the electronic throttle valve 72.

Although the shift progress rate PRat of the automatic transmission 12 is calculated from Equation (1) in the example, Equation (1) is merely exemplification and the shift progress rate PRat may be calculated from another calculation method. The shift progress rate PRat may be calculated based on a parameter other than the input rotation speed Nin of the automatic transmission 12, for example, based on an elapsed time from the start of a shift.

Although the shift progress rate PRat of the automatic transmission 12 is zero at the start of the shift and becomes one at the completion of the shift in the example, the shift progress rate PRat may not change from zero to one in this way.

Although the supercharging pressure Pcmout of the supercharger 54 rises by itself in the rising process in FIG. 5 of the example, the supercharging pressure Pcmout may be adjusted through feed-back control to converge to a predetermined target supercharging pressure and the supercharging pressure Pcmout adjusted through the feed-back control may be subjected to the supercharging pressure suppression control.

Although the shift of the automatic transmission 12 is triggered by accelerator-on, i.e., depressing of the accelerator pedal 88, in the time chart of FIG. 5 in the example, the actuation of the electronic throttle valve 72 in the closing direction in the supercharging pressure suppression control may be limited in a shift of the automatic transmission 12 not triggered by the accelerator-on. For example, a downshift or an upshift of the automatic transmission 12 may be generated by a shift lever operation, i.e., a sequential shift operation, of a driver.

Although the downshift of the automatic transmission 12 is performed in the time chart of FIG. 5 in the example, the actuation of the electronic throttle valve 72 in the closing direction in the supercharging pressure suppression control may be limited during an upshift of the automatic transmission 12. The actuation of the electronic throttle valve 72 in the closing direction in the supercharging pressure suppression control may be limited during a shift other than the clutch-to-clutch shift of the automatic transmission 12.

Although the vehicle 6 does not include an electric motor as a drive force source for running in the example, the vehicle 6 may be a hybrid vehicle including an electric motor for running.

Although the vehicle 6 includes the torque converter 14 as depicted in FIG. 1 in the example, the torque converter 14 is not essential.

Although the supercharger 54 is an exhaust turbine supercharger in the example, the supercharger 54 may be a mechanical type supercharger, i.e., mechanical supercharger, rotationally driven by rotation of the output shaft 13 of the engine 10. If the supercharger 54 is a mechanical supercharger, the exhaust bypass path 66 and the waist gate valve 68 are not disposed, while a clutch is disposed that selectively couples the output shaft 13 of the engine 10 and a rotation shaft of the mechanical supercharger.

### NOMENCLATURE OF ELEMENTS

6: vehicle 10: engine 12: automatic transmission 38: drive wheels 52: electronic control device (vehicle engine control device) 54: supercharger 72: electronic throttle valve (supercharging pressure adjustment mechanism)

1. A vehicle engine control device in a vehicle including an engine, a supercharger pressurizing intake air of the engine, a supercharging pressure adjustment mechanism adjusting a supercharging pressure of the supercharger, and a stepped automatic transmission outputting power of the engine to drive wheels, the vehicle engine control device providing supercharging pressure suppression control of actuating the supercharging pressure adjustment mechanism so as to suppress a rise in the supercharging pressure in a process of a rise in the supercharging pressure of the supercharger,
the supercharging pressure suppression control being limited during a shift of the automatic transmission as compared to after the shift of the automatic transmission.

2. The vehicle engine control device of claim 1, wherein
the shift of the automatic transmission associated with limitation on the supercharging pressure suppression control is a power-on downshift executed due to a depressing operation of an accelerator pedal.

3. The vehicle engine control device of claim 1, wherein
the limitation on the supercharging pressure suppression control is to limit actuation of the supercharging pressure adjustment mechanism in the supercharging pressure suppression control when a progress rate of a shift of the automatic transmission is closer to completion of the shift.

4. The vehicle engine control device of claim 1, wherein
the limitation on the supercharging pressure suppression control is to delay a start time of actuation of the supercharging pressure adjustment mechanism until completion of the shift of the automatic transmission when the supercharging pressure suppression control is provided.

5. The vehicle engine control device of claim 1, wherein
actuation of the supercharging pressure adjustment mechanism in the supercharging pressure suppression control is limited when a progress rate of the shift is equal to or greater than a predefined shift progress rate threshold value during a shift of the automatic transmission.

6. The vehicle engine control device of claim 1, wherein
the supercharging pressure suppression control is provided when a supercharging pressure of the supercharger is equal to or greater than a predefined supercharging pressure suppression threshold value.
